(19) United States
(12) Patent Application Publication
(10) Pub. No.: US 2005/0007509 A1
(43) Pub. Date: Jan. 13, 2005

(54) Electro-optical device and electronic apparatus

(75) Inventors: Katsunori Yamazaki, Matsumoto-shi (JP); Tsuyoshi Maeda, Ryuo-cho (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/848,130

(22) Filed: May 19, 2004

(30) Foreign Application Priority Data
Jun. 3, 2003 (JP) 2003-158187

(51) Int. Cl. G02F 1/136

(52) U.S. Cl. 349/41

(57) ABSTRACT

The invention provides a three-level driving method that prevents or reduces contrast degradation due to a leakage current. Three-level driving drives a pixel by using signal voltages whose data magnitude is smaller than 3 V. The pixel includes a liquid crystal element and a two-terminal switching element connected in series with the liquid crystal element. In the optical characteristics of the liquid crystal element, a difference between a first effective voltage of liquid crystal, at which the optical characteristic starts to change after increasing from zero voltage, and a second effective voltage, at which the maximum optical characteristic occurs, is smaller than 3 V.

### BACKGROUND OF THE INVENTION

1. Field of Invention

The present invention relates to an electro-optical device and an electronic apparatus. In particular, the invention relates to three-level driving of a pixel including a two-terminal switching element.

2. Description of Related Art

The related art includes three-level driving and four-level driving to drive a pixel including a two-terminal switching element. In the related art, three-level driving was proposed prior to four-level driving. Three-level driving drives a TFD element by using two selection voltages±Vsel and one hold voltage Vhld (=0 V). In general, a data magnitude, namely, the magnitude of a change between the two selection voltages±Vsel, is set to 4 V to 5 V. In three-level driving, a voltage applied to a two-terminal switching element during a hold period is relatively high and therefore a leakage current frequently occurs, which decreases particularly the voltage of an on-state pixel. Accordingly, three-level driving disadvantageously causes flickering and poor contrast.

On the other hand, four-level driving was proposed to solve such problems associated with three-level driving. For example, as is disclosed in Japanese Examined Patent Application Publication No. 5-34653, four-level driving drives a TFD element by using two selection voltages±Vsel and two hold voltages±Vhld. In four-level driving, a voltage applied to a TFD element is lower than that used in three-level driving during a hold period, and therefore the leakage current can be reduced compared to three-level driving. However, four-level driving must output the two hold voltages±Vhld. Consequently, a scanning line driving circuit that controls the hold voltages disadvantageously becomes complicated.

### SUMMARY OF THE INVENTION

Accordingly, the present invention provides three-level driving that reduces or prevents contrast degradation due to leakage currents.

According to a first aspect of the present invention, an electro-optical device includes pixels and a driving unit to drive each pixel by three-level driving using signal voltages having a data magnitude smaller than 3 volts. Each pixel includes a liquid crystal element and a two-terminal switching element connected in series with the liquid crystal element. A voltage difference between a first effective applied voltage at which an optical characteristic of the liquid crystal element starts to change after increasing from no applied voltage and a second effective applied voltage at which the optical characteristic is maximized is smaller than 3 volts.

According to a second aspect of the present invention, an electro-optical device includes a display unit having a plurality of scanning lines, a plurality of data lines, and a plurality of pixels associated with intersections of the scanning lines and the data lines, and a scanning line driving circuit to apply a selection voltage having a plurality of levels and a hold voltage having one level to the plurality of scanning lines, and a data line driving circuit to apply signal voltages having a data magnitude smaller than 3 volts to the plurality of data lines. Each pixel includes a liquid crystal element and a two-terminal switching element connected in series with the liquid crystal element. A voltage difference between a first effective applied voltage at which an optical characteristic of the liquid crystal element starts to change after increasing from no applied voltage and a second effective applied voltage at which the optical characteristic is maximized is smaller than 3 volts.

According to the first and second aspects of the present invention, a voltage difference between the first effective voltage and the second effective voltage is preferably smaller than or equal to the data magnitude of the signal voltages. Additionally, the data magnitude of the signal voltages is preferably smaller than or equal to 2.5 volts . Furthermore, the liquid crystal element preferably includes liquid crystal driven in a birefringence mode, and in particular, VAN liquid crystal.

According to a third aspect of the present invention, an electronic apparatus including the electro-optical device according to the first aspect or the second aspect of the present invention is provided.

### BRIEF DESCRIPTION OF THE DRAWINGS

FIG. 1 is a schematic of an electro-optical device according to a first exemplary embodiment;

FIG. 2 is a schematic of an equivalent circuit of a pixel;

FIG. 3 is a graph that shows a characteristic of VAN liquid crystal;

FIG. 4 is a graph explaining three-level driving;

FIG. 5 is a graph that shows a voltage status based on Vseg; and

FIG. 6 is a graph showing a contrast versus data magnitude characteristic.

### DETAILED DESCRIPTION OF PREFERRED EMBODIMENTS

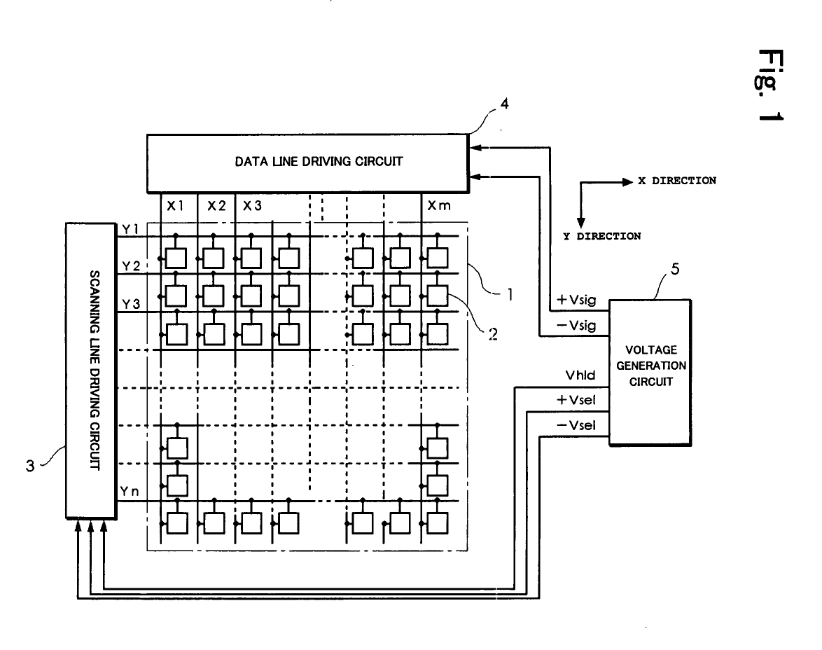

FIG. 1 is a schematic of an electro-optical device according to an exemplary embodiment. A display section 1 is an active matrix panel in which switching elements drive liquid crystal layers. In the active matrix panel, pixels 2 are arranged in a matrix of m dots by n lines on a two-dimensional plane. The display section 1 has n scanning lines Y1-Yn, each extending in a line direction, namely, in the X direction, and m data lines X1-Xm, each extending in a column direction, namely, in the Y direction. The scanning lines Y1-Yn intersect with the data lines X1-Xm and the pixels 2 are disposed at the intersections.

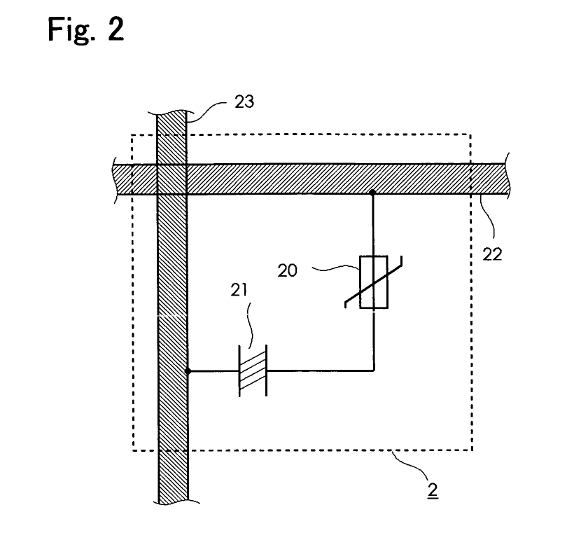

FIG. 2 is a schematic of an equivalent circuit of the pixel 2. Each pixel 2 has a TFD element 20 and a liquid crystal element 21. The TFD element 20 is one type of two-terminal switching element and has non-linear current-voltage characteristics. That is, a current rarely flows near a voltage (absolute |V |) of zero, whereas, once the voltage exceeds a threshold voltage |Vth |, the current abruptly flows in accordance with the voltage increase. One end of the TFD element 20 is connected to a scanning electrode 22 that corresponds to a scanning line Y. Herein, the scanning line Y is any one of the scanning lines Y1-Yn. The liquid crystal element 21 is disposed between a signal electrode 23 that corresponds to a data line X and the other end of the TFD element 20. The data line X is any one of the data lines X1-Xn. The liquid crystal element 21 is composed of a pair of electrodes and a liquid crystal layer therebetween. The liquid crystal element 21 is charged or discharged such that the TFD element 20 turns on when a scanning signal having a voltage level and a data signal having another voltage level are supplied to the pixel 2. A potential difference between the electrodes of the liquid crystal element 21 determines the light transmittance (or light reflectance) of the liquid crystal layer. A gray level of the pixel is displayed in accordance with the potential difference. In FIG. 2, although the TFD element 20 is disposed on the scanning electrode 22 side and the liquid crystal element 21 is disposed on the signal electrode 23 side, the positions may be reversed.

In this exemplary embodiment, the liquid crystal element 21 is Vertically Alignment Nemastic (VAN) liquid crystal having characteristics shown in FIG. 3. In the liquid crystal element 21, VAN liquid crystal having negative dielectric anisotropy is disposed between substrates having alignment layers with slightly tilted homeotropic alignment. The liquid crystal element 21 has a transmission versus effective voltage characteristic (a V-T characteristic), in which the transmission is 0% in a low effective voltage range while the transmission starts to non-linearly increase as the effective voltage increases after exceeding a voltage V1. The transmission reaches its maximum at a voltage V2, and then starts to decrease. In this exemplary embodiment, liquid crystal having a steep V-T characteristic must be used for the reason described below. In particular, a voltage difference ΔV between the voltages V1 and V2 must be smaller than 3 V, and preferably smaller than or equal to 2.5 V. The VAN liquid crystal having the characteristic shown in FIG. 3 has a voltage difference ΔV of about 1.3 V, thus fulfilling this requirement. On the other hand, in a capacitance versus effective voltage characteristic (a V-C characteristic), the capacitance gradually increases in accordance with an increase of the effective voltage.

A voltage generation circuit 5 generates five fixed levels of voltages±Vsig, Vhld, and ±Vsel. The positive and negative signal voltages±Vsig are supplied to a data line driving circuit 4. The positive and negative selection voltages±Vsel and the hold voltage Vhld (=0 V) are supplied to a scanning line driving circuit 3. The polarity of voltages is determined based on a reference voltage Vss. Voltages higher than Vss are positive and voltages lower than Vss are negative.

The scanning line driving circuit 3 and the data line driving circuit 4 together function as a driving section that drives the pixels 2, which constitute the display section 1. The scanning line driving circuit 3 is mainly composed of a shift register and an output circuit. The scanning line driving circuit 3 sequentially selects each of the scanning lines Y1-Yn for every one horizontal scanning period (1H) by outputting scanning signals to the scanning lines Y1-Yn. In such a line-at-a-time scanning, a pixel line to which data are written is sequentially selected in a predetermined direction (generally, from the top to the bottom) during one vertical scanning period (1F). Herein, for three-level driving, the scanning signal output to the scanning lines Y1-Yn has three voltage levels, namely, positive and negative selection voltages±Vsel and the hold voltage Vhld. The polarities of the selection voltages±Vsel, which are applied to the scanning lines Y1-Yn, are inverted for every frame. In addition, the polarity of the scanning line Y of odd number is inverted from that of the scanning line Y of even number in the same frame to reduce flickering.

The data line driving circuit 4 is mainly composed of a shift register, a line-latch circuit, and an output circuit. The data line driving circuit 4 supplies data to be written into a target pixel line to the data lines X1-Xm by voltage level in conjunction with the scanning line driving circuit 3. During 1H, the data line driving circuit 4 outputs all data for the current pixel line and simultaneously latches data to be written into a pixel line during the next horizontal scanning period in a point-at-a-time scanning manner. During each 1H, m numbers of data, which correspond to the number of the data lines X1-Xm, are sequentially latched. During the next 1H, the latched m pieces of data are output to the respective data lines X1-Xm at the same time. Voltage levels of the data signals output to the data lines X1-Xm are positive and negative signal voltages±Vsig. A data magnitude |2Vsig| of the signal voltages±Vsig must be smaller than 3 V, and preferably smaller than or equal to 2.5 V. The polarity of the selection voltages±Vsel applied to the scanning line Y determines which one of the signal voltages±Vsig becomes an on-drive voltage (voltage that drives the liquid crystal). The reverse polarity of the selection voltage is the on-drive voltage. For example, when a positive selection voltage+Vsel is applied, a negative signal voltage−Vsig is the on-drive voltage and a positive signal voltage+Vsig is an off-drive voltage (voltage that does not drive the liquid crystal).

The gray level of the pixel 2 depends on the time density of the on-drive voltage, namely, an on duty ratio in the selection period (1H), during which the selection voltage+Vsel or −Vsel is applied to the scanning line Y. An example is described below using the VAN liquid crystal shown in FIG. 3, driven in a normally black mode. When an off-drive voltage Voff is applied throughout the entire period of 1H (on duty ratio=0), the TFD element 20 turns on and the liquid crystal element 21 is charged until a liquid crystal voltage Vlcd reaches a voltage Vw, where Vw=|Vsel−Vsig|-−|Vth|. However, in the case of Vlcd=Vw, this voltage does not exceed the threshold voltage that drives the liquid crystal layer, and thereby black is displayed. In contrast, if an on-drive voltage Von is applied in part of the selection period (on duty ratio≠0), more charge than that in the black display is accumulated in the liquid crystal element 21 so that the liquid crystal voltage Vlcd exceeds the threshold voltage of the liquid crystal layer. Accordingly, the liquid crystal layer is driven to display a half tone, namely, a gray level. Subsequently, the display approaches to white as the on duty ratio increases.

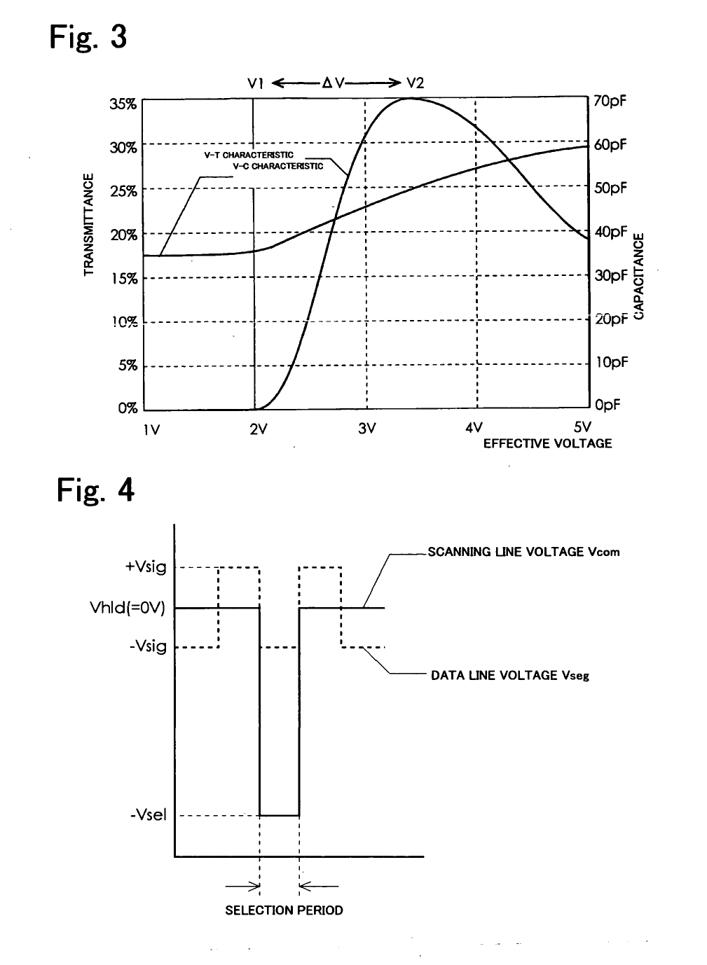

According to this exemplary embodiment, three-level driving that reduces or prevents degradation of contrast can be achieved by reducing leakage current. A significant point is described below with reference to FIGS. 4 to 6. FIG. 4 is a graph explaining the three-level driving in the case where the selection voltage−Vsel of a negative polarity is applied. Herein, a voltage of the scanning line Y connected to the pixel 2 is Vcom and a voltage of the data line X connected to the pixel 2 is Vseg. The three-level driving is identical to four-level driving in that Vseg=±Vsig is set and Vcom=±Vsel is set in a selection period. However, the Vhld of the three-level driving is set to one value (=0 V) during a hold period other than the selection period, while the Vhld of the four-level driving is set to two values±Vhld (|Vhld|≠0 V).

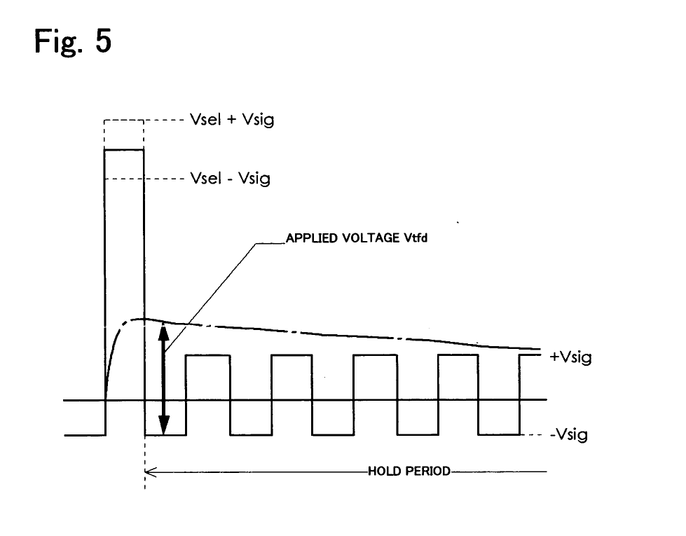

FIG. 5 shows the voltage based on Vseg. As shown in FIG. 5, since the hold voltage Vhld is 0 V, a voltage Vtfd applied to the TFD element 20 is relatively large during a hold period so that charge in the pixel 2, in particular, in an on-state, leaks, thereby decreasing the voltage of the pixel 2. Accordingly, the liquid crystal in a normally white mode displays brighter black, thus decreasing the contrast. To reduce or suppress the degradation of the contrast, the leakage current should be reduced by decreasing the data magnitude |2Vsig| of the signal voltages±Vsig. Data magnitudes for enhanced or optimal contrast obtained through experiments and simulations by the present inventors are described below.

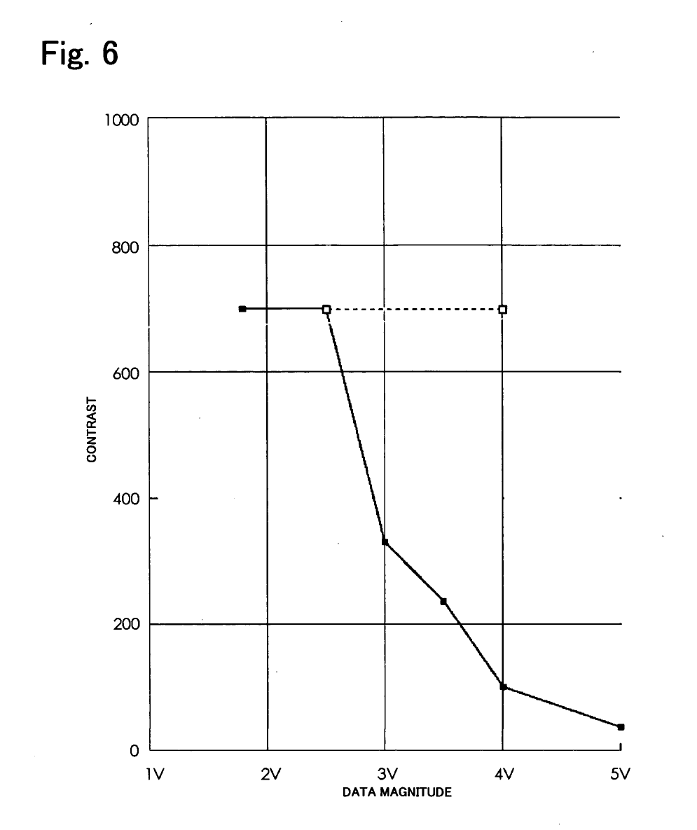

FIG. 6 is a graph showing a contrast versus data magnitude characteristic obtained through experiments and simulations. In FIG. 6, black squares denote a characteristic of the three-level driving and white squares denote that of the four-level driving under the same conditions. It is found that, in the range of the data magnitude greater than or equal to 3 V, the contrast is smaller than 300 due to leakage current. Accordingly, suitable display quality cannot be obtained. In contrast, if the data magnitude is smaller than 3 V, a contrast greater than 300 is obtained. In particular, a data magnitude smaller than or equal to 2.5 V provides a contrast of about 700. The contrast in the range of the data magnitude between 2.5 V and 3 V is practical if the gap between pixels in a display panel is structurally reduced to decrease light leakage. As for the theoretical lower limit, the data magnitude greater than 0 V can reduce or suppress the leakage current of the TFD element 20 during the hold period.

If the data magnitude is smaller than 3 V, liquid crystal capable of operating in this range is required. More specifically, liquid crystal having a characteristic in which the above-described voltage difference ΔV is smaller than 3 V is required. In particular, liquid crystal in which ΔV is smaller than a selected data magnitude can provide more suitable contrast. The above-described VAN liquid crystal is a typical one having a steep optical characteristic and is the best exemplary embodiment under the required conditions. However, the present invention is not limited thereto; it can be applied to various types of liquid crystal that are driven in a birefringence mode, including Super Homeotropic (SH) liquid crystal.

Additionally, according to the exemplary embodiment, the circuit configuration can be simplified. That is, the data line driving circuit 4 can operate at a low voltage by using VAN liquid crystal having a steep optical characteristic and by reducing the data magnitude. Accordingly, the data line driving circuit 4 can have a low withstand voltage and can be miniaturized to reduce the size of an IC chip of the data line driving circuit 4. In addition, compared with the four-level driving, the three-level driving reduces the numbers of output transistors and level shifter circuits that constitute the scanning line driving circuit 3. Also, it eliminates the need for registers that store output potentials during a hold period. These advantages further reduce the cost of the electro-optical device.

Additionally, according to the exemplary embodiment, low power consumption can be realized by using VAN liquid crystal having a steep optical characteristic and by reducing the data magnitude. Power of the display panel is mainly consumed by parasitic capacitance between a segment electrode and a common electrode. The consumed power is proportional to the value obtained by the following operation: the parasitic capacitance is multiplied by the square of the data magnitude, and then the resulting value is multiplied by the switching frequency of the selection voltages±Vsel. Hence, for example, if the data magnitude is reduced from the present 4 V to 2.5 V, the power consumption is reduced to 40% of the present power consumption. If the data magnitude is reduced to 1.8 V, the power consumption is reduced to 20% of the present power consumption.

The present invention is not limited to the three-level driving shown in FIG. 4; it can be applied to three-level driving having a reset function. In the three-level driving having the reset function, a reset voltage Vrst is applied during the first half of the selection period and the selection voltage Vsel is applied during the second half of the selection period. The reset voltage Vrst has a reverse polarity of the selection voltage Vsel and an absolute |Vrst| is determined to be greater than an absolute |Vsel|. Japanese Unexamined Patent Application Publication No. 9-269475 discloses a specific setting method of the reset voltage Vrst.

Furthermore, the electro-optical device according to the exemplary embodiment can be included in various types of electronic apparatuses, such as TVs, projectors, mobile telephones, mobile terminals, mobile computers, and personal computers. Such electronic apparatuses including the above-described electro-optical device have increased commercial value and stronger market appeal.

[Exemplary Advantages]

According to the present invention, in three-level driving of a pixel including a two-terminal switching element, leakage current can be reduced, thereby reducing or preventing degradation of contrast.

1. An electro-optical device, comprising:
pixels, each having a liquid crystal element and a two-terminal switching element connected in series with the liquid crystal element; and
a driving unit to drive each pixel by three-level driving using signal voltages having a data magnitude smaller than 3 volts;
the pixel having a first effective applied voltage at which an optical characteristic of the liquid crystal element starts to change after increasing from no applied voltage, and a second effective applied voltage at which the optical characteristic is maximized, a voltage difference between the first effective voltage and the second effective voltage being smaller than 3 volts.

2. An electro-optical device, comprising:
a display unit having a plurality of scanning lines, a plurality of data lines, and a plurality of pixels associated with intersections of the scanning lines and the data lines, each of the pixels having a liquid crystal element and a two-terminal switching element connected in series with the liquid crystal element;
a scanning line driving circuit to apply a selection voltage having a plurality of levels and a hold voltage having one level to the plurality of scanning lines; and
a data line driving circuit to apply signal voltages having a data magnitude smaller than 3 volts to the plurality of data lines;
the display unit having a first effective applied voltage at which an optical characteristic of the liquid crystal element starts to change after increasing from no applied voltage, and a second effective applied voltage at which the optical characteristic is maximized, a voltage difference between the first effective voltage and the second effective voltage being smaller than 3 volts.

3. The electro-optical device according to claim 1, a voltage difference between the first effective voltage and the second effective voltage being smaller than or equal to the data magnitude of the signal voltages.

4. The electro-optical device according to claim 1, the data magnitude of the signal voltages being smaller than or equal to 2.5 volts .

5. The electro-optical device according to claim 1, the liquid crystal element including liquid crystal driven in a birefringence mode.

6. The electro-optical device according to claim 5, the liquid crystal element including VAN liquid crystal.

7. An electronic apparatus, comprising:
the electro-optical device according to claim 1.
